(19) United States
(12) Patent Application Publication
(10) Pub. No.: US 2026/0237765 A1
(43) Pub. Date: Aug. 13, 2026

(54) APPARATUS AND METHOD FOR PRESSURIZED PRE-CHARGE

(71) Applicant: SK ON CO., LTD., Seoul (KR)

(72) Inventors: Young Bee KIM, Daejeon (KR); Seung Hoon JUNG, Daejeon (KR)

(21) Appl. No.: 19/455,837

(22) Filed: Jan. 22, 2026

(30) Foreign Application Priority Data
Feb. 7, 2025 (KR) 10-2025-0016037

(51) Int. Cl. H01M 10/44; H01M 10/42

(52) U.S. Cl. CPC H01M 10/441; H01M 10/425; H01M 10/445; H01M 2010/4271

(57) ABSTRACT

An apparatus for pressurized pre-charging according to an embodiment of the present disclosure is configured to include a pressurization device applying pressure to or releasing applied pressure from a plurality of battery cells; and a pre-charger performing first pre-charging on the plurality of battery cells in a state pressurized by the pressurization device before a rest period, stopping the first pre-charging during the rest period, and performing second pre-charging on the plurality of battery cells in a state pressurized by the pressurization device after the rest period, wherein the pressurization device performs pressurization against the plurality of battery cells for the first pre-charging and the second pre-charging, and performs depressurization on the plurality of battery cells during the rest period.

### CROSS-REFERENCE TO RELATED APPLICATION(S)

This patent document claims the priority and benefits of Korean Patent Application No. 10-2025-0016037 filed on Feb. 7, 2025, the disclosure of which is incorporated herein by reference in its entirety.

### TECHNICAL FIELD

The disclosure and implementations disclosed in this patent document generally relate to an apparatus and method for pressurized pre-charging that may be applied to an operation of performing pre-charging of a battery during a process for manufacturing the battery.

### BACKGROUND

In general, a pressurized pre-charging (PPC) process may include first pre-charging (Pre-charge #1), a rest period (Rest), and second pre-charging (Pre-charge #2).

During the rest period (Rest) of the pressurized pre-charging (PPC) process, charging may not proceed, and the entire battery cell may entirely wait for a set time of the process recipe while being maintained in a pressurized state. For example, when the first pre-charging (Pre-charge #1) is performed, a solid electrolyte interphase (SEI) layer may be formed on an electrode surface, and gas may be generated due to a side reaction.

Most of the gas generated during the process may rise and gather toward a gas pocket in an upper portion due to a state in which plates are compressed. However, there may be a problem in that some fine gas among them may be trapped between an electrode and a separator, contributing to formation of unbalanced polarization within the electrode. Specifically, the trapped gas causes a locally unbalanced degree of charging and unstable activation, thereby hindering formation of the SEI layer.

### SUMMARY

An embodiment of the present disclosure provides an apparatus and method for pressurized pre-charging that may redistribute gas trapped on an electrode surface by performing depressurization during a rest period between a first pre-charging and a second pre-charging in a battery formation process, thereby contributing to stabilization of a solid electrolyte interphase (SEI) formed on the electrode surface of a battery cell.

Technical solutions of the present disclosure are not limited to those mentioned above, and other technical solutions not mentioned will be clearly understood by a person having ordinary skill in the art of the present disclosure from the description below.

According to an aspect of the present disclosure, an apparatus for pressurized pre-charging (PPC) including a pressurization device applying pressure to or releasing applied pressure from a plurality of battery cells; and a pre-charger performing first pre-charging on the plurality of battery cells in a state pressurized by the pressurization device before a rest period, stopping the first pre-charging during the rest period, and performing second pre-charging on the plurality of battery cells in a state pressurized by the pressurization device after the rest period, wherein the pressurization device performs pressurization against the plurality of battery cells for the first pre-charging and the second pre-charging, and performs depressurization on the plurality of battery cells during the rest period, may be proposed.

The apparatus for pressurized pre-charging (PPC) may be configured to further include a controller controlling the pressurization device to perform depressurization on the plurality of battery cells during the rest period between the first pre-charging and the second pre-charging.

The pressurization device may be configured to perform depressurization on the plurality of battery cells during the rest period under control of the controller.

The pre-charger may be configured to include a first pre-charging unit including a first charging unit and a first charging state determination unit, and wherein the first charging unit initiates the first pre-charging for the plurality of battery cells according to a first control signal of the controller, and terminates the first pre-charging according to a first charging completion signal input from the first charging state determination unit, and the first charging state determination unit compares a charging state for the plurality of battery cells with a preset first charging state, and outputs the first charging completion signal to the first charging unit when the charging state exceeds the first charging state.

The pre-charger may be configured to include a second pre-charging unit including a second charging unit and a second charging state determination unit, and wherein the second charging unit initiates the second pre-charging for the plurality of battery cells according to a second control signal of the controller, and terminates the second pre-charging according to a second charging completion signal input from the second charging state determination unit, and the second charging state determination unit compares a charging state for the plurality of battery cells with a preset second charging state, and outputs the second charging completion signal to the second charging unit when the charging state exceeds the second charging state.

The rest period may be configured to correspond to a period from a point in time at which the first pre-charging is terminated to a point in time at which a preset time elapses.

The controller may be configured to generate a pressure control signal for controlling depressurization of the plurality of battery cells during a depressurization time set within the rest period, and provides the pressure control signal to the pressurization device.

A point in time of the depressurization time may be configured to be set as a point in time, equal to or later than a point in time of the rest period, and an end point of the depressurization time may be set as a point in time, equal to or earlier than an end point of the rest period.

The depressurization time may be configured to be set to be 2 minutes or longer and 12 minutes or less.

The pressurization device may be configured to include a movement adjusting unit and a plate portion, and wherein the movement adjusting unit adjusts movement of the plate portion for pressurization against and depressurization on the plurality of battery cells according to a pressure control signal of the controller, and the plate portion includes a plurality of plates, and the plurality of plates move and adjust a movable plate relative to a fixed plate in conjunction with an operation of the movement adjusting unit, to perform pressurization against or depressurization on the plurality of battery cells.

In addition, according to another aspect of the present disclosure, a method for pressurized pre-charging (PPC) including a first pre-charging operation of performing first pre-charging on a plurality of battery cells pressurized by a pressurization device before a rest period, with a pre-charger; a depressurization operation of performing depressurization on the plurality of battery cells during the rest period after the first pre-charging operation, by the pressurization device; and a second pre-charging operation of performing second pre-charging on the plurality of battery cells repressurized by the pressurization device after the depressurization operation, by the pre-charger, may be proposed.

In the depressurization operation, the pressurization device may be configured to perform depressurization on the plurality of battery cells during the rest period according to control of a controller.

The first pre-charging operation may be configured to include a first initiation operation of initiating the first pre-charging for the plurality of battery cells by the pre-charger according to control of the controller; and a first termination operation of terminating the first pre-charging when a charging state of the plurality of battery cells exceeds a preset first charging state.

The second pre-charging operation may be configured to include a second initiation operation of initiating the second pre-charging for the plurality of battery cells by the pre-charger according to control of the controller; and a second termination operation of terminating the second pre-charging when a charging state of the plurality of battery cells exceeds a preset second charging state.

The rest period may be configured to correspond to a period from a point in time at which the first pre-charging is terminated to a point in time (T2) at which a preset time elapses.

The depressurization operation may be configured to perform depressurization on the plurality of battery cells during a depressurization time set within the rest period range according to a pressure control signal of the controller, by the pressurization device.

A point in time of the depressurization time may be configured to be set as a point in time, equal to or later than a point in time of the rest period, and an end point of the depressurization time may be set as a point in time, equal to or earlier than an end point of the rest period.

The depressurization time may be configured to be set to be 2 minutes or longer and 12 minutes or less.

In addition, aspects of the present disclosure are not limited to the above-mentioned aspects, and another aspect can be additionally understood in a process described below.

### BRIEF DESCRIPTION OF DRAWINGS

Certain aspects, features, and advantages of the present disclosure may be illustrated by the following detailed description with reference to the accompanying drawings.

FIG. 1 is a conceptual diagram of an apparatus for pressurized pre-charging (PPC) according to an embodiment of the present disclosure.

FIG. 2 is an exemplary diagram of an apparatus for pressurized pre-charging (PPC).

FIG. 3 is an explanatory diagram of an operation process of an apparatus for pressurized pre-charging (PPC).

FIG. 4A is a shape of a battery cell, and FIG. 4B is a side schematic diagram of a pressurization device in which a battery cell is disposed.

FIG. 5A is an exemplary diagram of a progression from a pressurized state to a depressurized state, and FIG. 5B is an exemplary diagram of a progression from a depressurized state to a pressurized state.

FIG. 6 is a view illustrating a first pre-charging operation of a pre-charger.

FIG. 7 is a view illustrating a second pre-charging operation of a pre-charger.

FIG. 8 is an exemplary diagram of a rest time.

FIG. 9 is an exemplary diagram of a controller.

FIG. 10 is a conceptual diagram of a depressurization time.

FIG. 11 is an exemplary diagram of a depressurization time.

FIG. 12 is an exemplary diagram of a pressurization device.

FIG. 13 is a flow chart illustrating a method for pressurized pre-charging (PPC) according to an embodiment of the present disclosure.

FIG. 14 is an exemplary diagram for a depressurization operation.

FIG. 15 is an explanatory diagram for a pressurization operation, a depressurization operation, and a pressurization operation of pressurized pre-charging (PPC).

FIG. 16 is an exemplary diagram for a first pre-charging operation.

FIG. 17 is an exemplary diagram for a second pre-charging operation.

FIG. 18 is another exemplary diagram for a depressurization operation.

FIG. 19 is a table diagram for a delta V failure rate according to a depressurization time.

FIG. 20 is a graph illustrating delta V according to a depressurization time.

FIG. 21 is a graph for a thickness (Depth(s)) of an SEI layer formed on an electrode surface.

FIG. 22 is a block diagram of a computing device that may fully or partially implement an apparatus and method for pressurized pre-charging according to an embodiment of the present disclosure.

In the drawings and detailed description, like reference numerals may refer to like components. The drawings may not be to scale, and relative sizes, proportions, and depictions of the drawing elements may be enlarged or reduced from actual sizes for clarity, explanation, and convenience.

### DETAILED DESCRIPTION

Hereinafter, embodiments of the present disclosure will be further described with reference to specific experimental examples. Inventive and comparative examples included in experimental examples are merely illustrative of the present disclosure and do not limit the scope of the appended claims. It will be apparent to those skilled in the art that various changes and modifications to the examples may be possible within the scope and technical idea of the present disclosure, and it may be natural that such changes and modifications fall within the scope of the appended claims.

Since the present disclosure may make various changes and have various embodiments, specific embodiments will be illustrated in the drawings and described in detail. However, this may not be intended to limit the present disclosure to specific embodiments, and should be understood to include all changes, equivalents, and substitutes included in the spirit and technical scope of the present disclosure.

Terms such as first, second, or the like may be used to describe various components, but the components should not be limited by the terms. The above terms may be used only for the purpose of distinguishing one component from another. For example, a first component may be named a second component, and similarly, the second component may also be named a first component without departing from the scope of the present disclosure. The term “and/or” may include any of a plurality of related stated items or a combination of a plurality of related stated items.

The terms used in the present disclosure may be only used to describe specific embodiments, and may not be intended to limit the disclosure of this patent document. Singular expressions include plural expressions unless the context clearly dictates otherwise. In the present application, terms such as “include,” “comprise,” “have,” and the like may be intended to designate the presence of features, numbers, steps, operations, components, parts, or combinations thereof described in the specification, but may not be intended to indicate the presence of one or more other features. It should be understood that this does not exclude in advance possibility of existence or addition of elements, numbers, steps, operations, components, parts, or combinations thereof.

Unless otherwise defined, all terms used herein, including technical or scientific terms, have the same meaning as commonly understood by a person of ordinary skill in the technical field to which the present disclosure pertains. Terms defined in commonly used dictionaries should be interpreted as having a meaning consistent with the meaning in the context of the related technology, and should not be interpreted in an ideal or excessively formal sense unless explicitly defined in the present application.

Hereinafter, with reference to the attached drawings, embodiments of the present disclosure will be described in more detail.

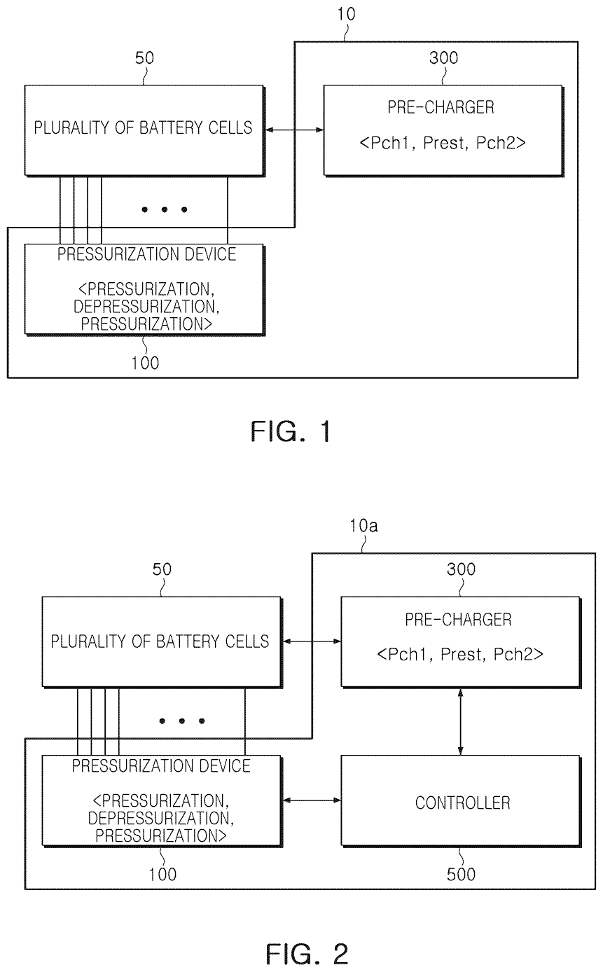

FIG. 1 is a conceptual diagram of an apparatus for pressurized pre-charging (PPC) according to an embodiment of the present disclosure.

Referring to FIG. 1, an apparatus 10 for pressurized pre-charging (PPC) according to an embodiment of the present disclosure may include a pressurization device 100 and a pre-charger 300.

The pressurization device 100 may apply physical pressure to a plurality of battery cells 50 or release the applied physical pressure.

The pre-charger 300 may perform a first pre-charging (Pch1) on the plurality of battery cells 50 in a state pressurized by the pressurization device 100 before a rest period (Prest), may stop the first pre-charging during the rest period (Prest), and may perform a second pre-charging (Pch2) on the plurality of battery cells 50 in a state pressurized by the pressurization device 100 after the rest period (Prest).

In addition, the pressurization device 100 may perform pressurization against the plurality of battery cells 50 for the first pre-charging (Pch1) and the second pre-charging (Pch2), and may perform depressurization on the plurality of battery cells 50 during the rest period (Prest).

In the present disclosure, the plurality of battery cells may be any one of currently known battery cells, such as pouch cells, cylindrical cells, square cells, or the like.

A battery including the battery cell of the present disclosure may be widely applied to green technology fields such as transportation vehicles such as electric vehicles, drones, or the like, battery charging stations, solar power generation, wind power generation, or the like, using batteries. In addition, battery of the present disclosure may be used in eco-friendly electric vehicles, hybrid vehicles, or the like to prevent climate change by suppressing air pollution and greenhouse gas emissions.

For each drawing of the present disclosure, unnecessary redundant descriptions of components having the same symbols and functions may be omitted as much as possible, and possible differences may be explained for each drawing.

FIG. 2 is an exemplary diagram of an apparatus for pressurized pre-charging (PPC).

Referring to FIG. 2, an apparatus 10a for pressurized pre-charging (PPC) may include a controller 500.

The controller 500 may control a pressurization device 100 to perform depressurization of a plurality of battery cells 50 during a rest period (Prest) between a first pre-charging (Pch1) and a second pre-charging (Pch2).

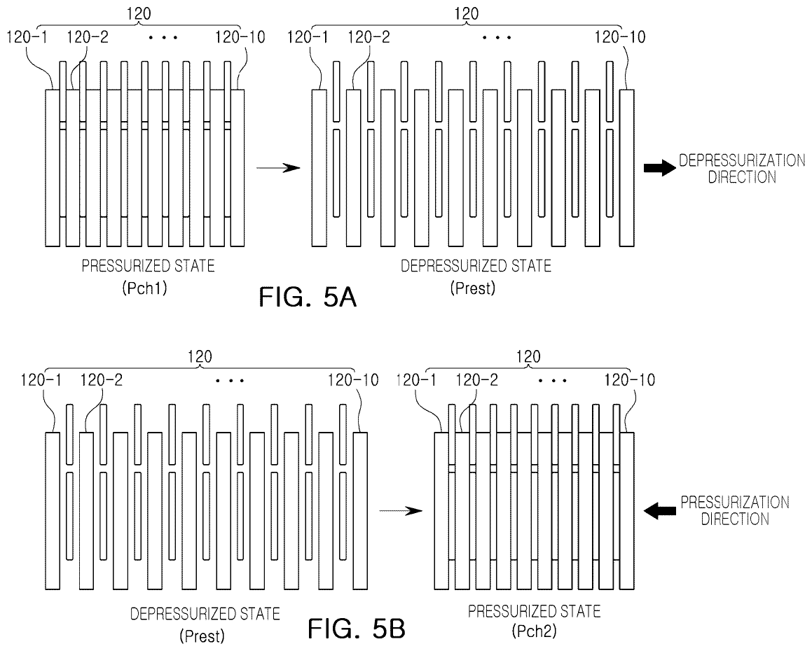

The pressurization device 100 may release physical pressurization of the plurality of battery cells 50 during the rest period (Prest) according to control of the controller 500. This will be described with reference to FIGS. 5A and 5B.

In the present disclosure, the pre-charger 300 and the controller 500 may include an individual processor, or may be implemented as a single integrated processor, respectively.

In addition, the pre-charger 300 and the controller 500 may be implemented as hardware element(s) or software element(s) or a combination thereof in at least one integrated circuit (IC) built into the apparatus 10a for pressurized pre-charging (PPC), and are not particularly limited to either one, respectively.

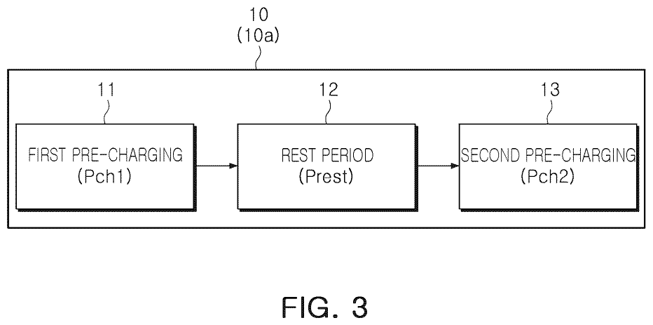

FIG. 3 is an explanatory diagram of an operation process of an apparatus for pressurized pre-charging (PPC).

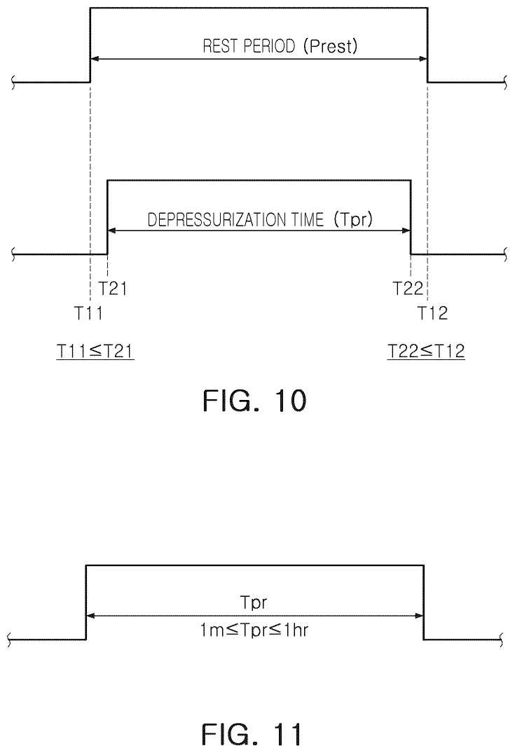

Referring to FIG. 3, an operation process of an apparatus for pressurized pre-charging (PPC) (10 of FIGS. 1, 10a of FIG. 2) may include a process 11 of performing first pre-charging (Pch1), a rest period (Prest) 12 in which an operation of the first pre-charging is stopped, and a process 13 of performing second pre-charging (Pch2).

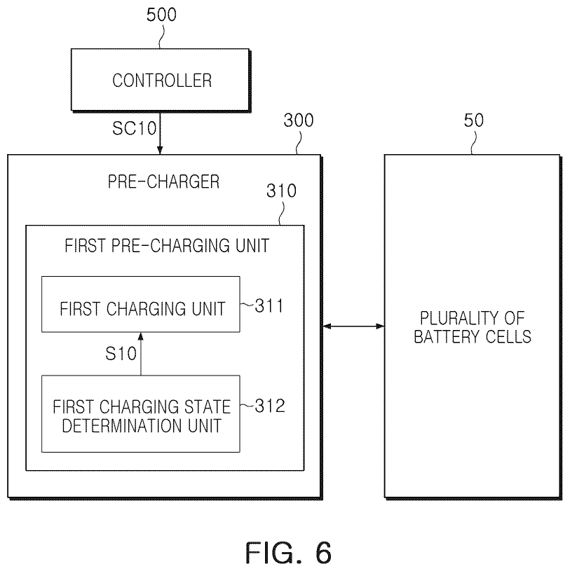

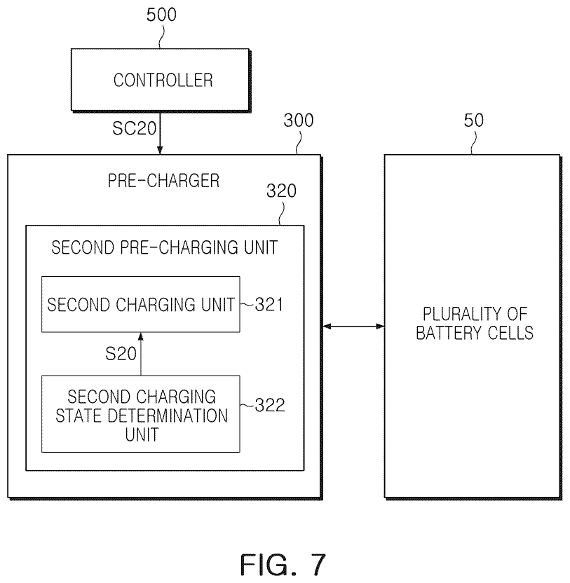

For example, in a process of performing first pre-charging (Pch1), charging may be performed on a plurality of battery cells 50 up to a first charging state (SOC1) set in advance, and during a rest period (Prest), charging may be stopped, and then in a process of performing second pre-charging (Pch2), charging may be performed on the plurality of battery cells 50 up to a second charging state (SOC2) set in advance. This will be explained with reference to FIGS. 6 and 7.

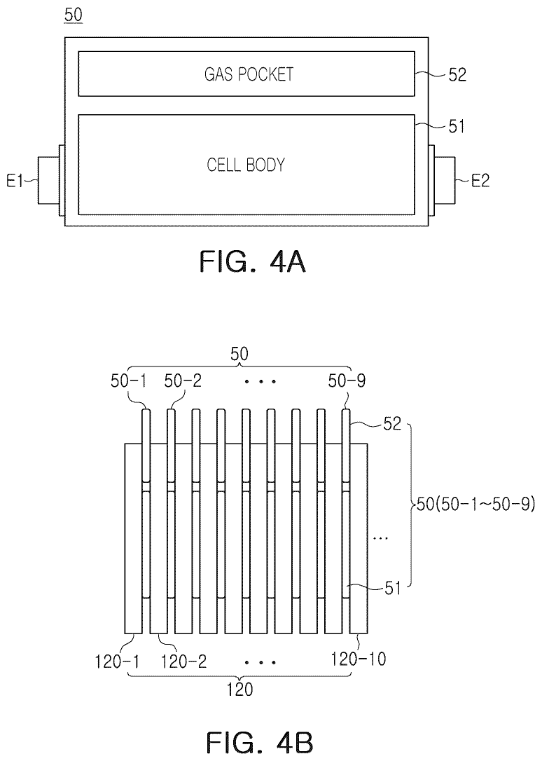

FIG. 4A is a shape of a battery cell, and FIG. 4B is a side schematic diagram of a pressurization device in which a battery cell is disposed.

Referring to FIG. 4A, a plurality of battery cells 50 (50-1 to 50-10, . . . ) may include a cell body 51 on which electrodes E1 and E2 are disposed on both sides, and a cell gas pocket 52, respectively.

Referring to FIG. 4B, an apparatus for pressurized pre-charging (PPC) (10 of FIGS. 1, 10a of FIG. 2) may include a plurality of battery cells 50 and a pressurization device 100.

The pressurization device 100 may have a plate portion 120 including a plurality of plates (120_1 to 120_10, . . . ), and the battery cells may be disposed one by one between the plurality of plates (120_1 to 120_10, . . . ).

For example, when a plate (e.g., 120_1) at one end of a plurality of plates (120_1 to 120_10, . . . ) is fixed, while the other plurality of plates (120_2 to 120_10, . . . ) may move in a pressurization direction or a depressurization direction by a moving means based on the fixed plate 120_1, a pressurization operation or a depressurization operation may be respectively performed for a plurality of battery cells 50 (50-1 to 50-10, . . . ).

FIG. 5 is an exemplary diagram of a progression from a pressurized state to a depressurized state, and FIG. 5B is an exemplary diagram of a progression from a depressurized state to a pressurized state.

Referring to FIG. 5B, a pressurization device 100 may perform depressurization of a plurality of battery cells 50 in a rest period (Prest) according to control of a controller 500.

For example, during a first pre-charging (Pch1) operation, movable plates 120_2 to 120_10 may move in a pressurized state on the left, based on a fixed plate 120_1, such that the plurality of battery cells 50 are in a pressurized state. Afterwards, when the first pre-charging (Pch1) operation is terminated, the movable plates 120_2 to 120_10 may move in a depressurized state on the left, based on the fixed plate 120_1, such that the plurality of battery cells 50 are in a depressurized state.

Referring to FIG. 5B, as an example, in the rest period (Prest), as described above, the movable plates 120_2 to 120_10 may move in a depressurized state on the left, based on the fixed plate 120_1, such that the plurality of battery cells 50 may be in a depressurized state. Afterwards, when the rest period (Prest) elapses, during a second pre-charging (Pch2) operation, the movable plates 120_2 to 120_10 may move in a pressurized state on the left, based on the fixed plate 120_1, such that the plurality of battery cells 50 may be in a pressurized state.

FIG. 6 is a view illustrating a first pre-charging operation of a pre-charger.

Referring to FIG. 6, a pre-charger 300 may include a first pre-charging unit 310 including a first charging unit 311 and a first charging state determination unit 312.

The first charging unit 311 can initiate a first pre-charging (Pch1) for a plurality of battery cells 50 according to a first control signal (SC10) of a controller 500, and may terminate the first pre-charging (Pch1) according to a first charging completion signal (S10) input from the first charging state determination unit 312.

The first charging state determination unit 312 may compare a charging state (SOC) for the plurality of battery cells 50 with a preset first charging state (SOC1), and may output the first charging completion signal (S10) to the first charging unit 311 when the charging state (SOC) exceeds the first charging state (SOC1).

FIG. 7 is a view illustrating a second pre-charging operation of a pre-charger.

Referring to FIG. 7, a pre-charger 300 may include a second pre-charging unit 320 including a second charging unit 321 and a second charging state determination unit 322.

The second charging unit 321 can initiate a second pre-charging (Pch2) for a plurality of battery cells 50 according to a second control signal (SC20) of a controller 500, and may terminate the second pre-charging (Pch2) according to a second charging completion signal (S20) input from the second charging state determination unit 322.

The second charging state determination unit 322 may compare a charging state (SOC) of the plurality of battery cells 50 with a preset second charging state (SOC2), and may output the second charging completion signal (S20) to the second charging unit 321 when the charging state (SOC) exceeds the second charging state (SOC2).

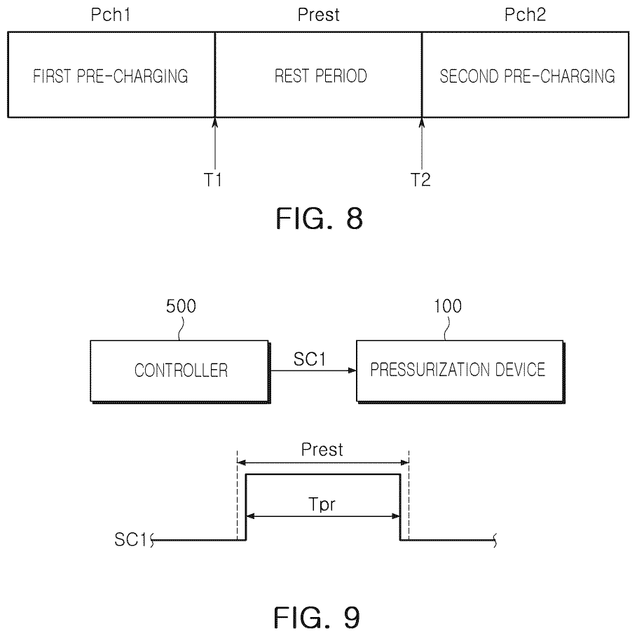

FIG. 8 is an exemplary diagram of a rest time.

Referring to FIG. 8, for example, a rest period (Prest) may correspond to a period (T2−T1) from a point in time (T1) at which a first pre-charging (Pch1) is terminated to a point in time (T2) at which a preset time (Tset) elapses.

FIG. 9 is an exemplary diagram of a controller.

Referring to FIG. 9, a controller 500 may generate a pressure control signal (SC1) for controlling depressurization of a plurality of battery cells 50 during a depressurization time (Tpr) set within a rest period (Prest), and may provide the pressure control signal (SC1) to a pressurization device 100.

For example, as illustrated in FIG. 9, when a pressure control signal (SC1) is on a high level, the pressure control signal (SC1) may be a control signal for depressurization, and when the pressure control signal (SC1) is on a low level, the pressure control signal (SC1) may be a control signal for pressurization.

For example, in further detail about depressurization, a pressure control signal (SC1) may be a signal having a high level at a depressurization time (Tpr). Alternatively, a pressure control signal (SC1) may be a signal having a low level at a depressurization time (Tpr). For example, the high level and the low level may be voltage levels.

FIG. 10 is a conceptual diagram of a depressurization time.

Referring to FIG. 10, a point in time of a depressurization time (Tpr) may be set as a point in time (T21), equal to or later than a point in time (T11) of a rest period (Prest), and an end point of the depressurization time (Tpr) may be set as a point in time (T22), equal to or earlier than an end point (T12) of the rest period (Prest).

In the present disclosure, the depressurization time (Tpr) may have an effect of lowering a delta V defect rate at 1 minute or longer, and may also have the effect at 1 hour or longer. However, since a long time of 1 hour or longer has a disadvantage of making a process time too long under a process environment, it is necessary to have the effect at the shortest possible time, and referring to FIG. 11, it may be explained that the effect of lowering the delta V defect rate may be achieved even at a relatively short depressurization time (Tpr).

FIG. 11 is an exemplary diagram of a depressurization time.

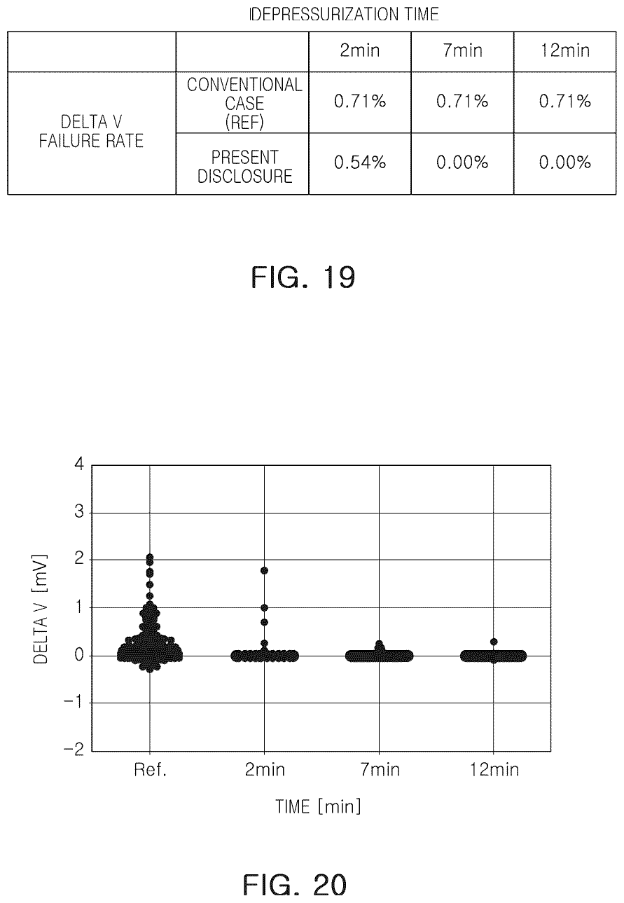

Referring to FIG. 11, for example, a depressurization time (Tpr) may be set to be 2 minutes or longer and 12 minutes or less. When the depressurization time (Tpr) is 2 minutes or longer and 12 minutes or less, an effect of lowering a delta V defect rate may be achieved, and this will be explained with reference to FIGS. 19 to 21.

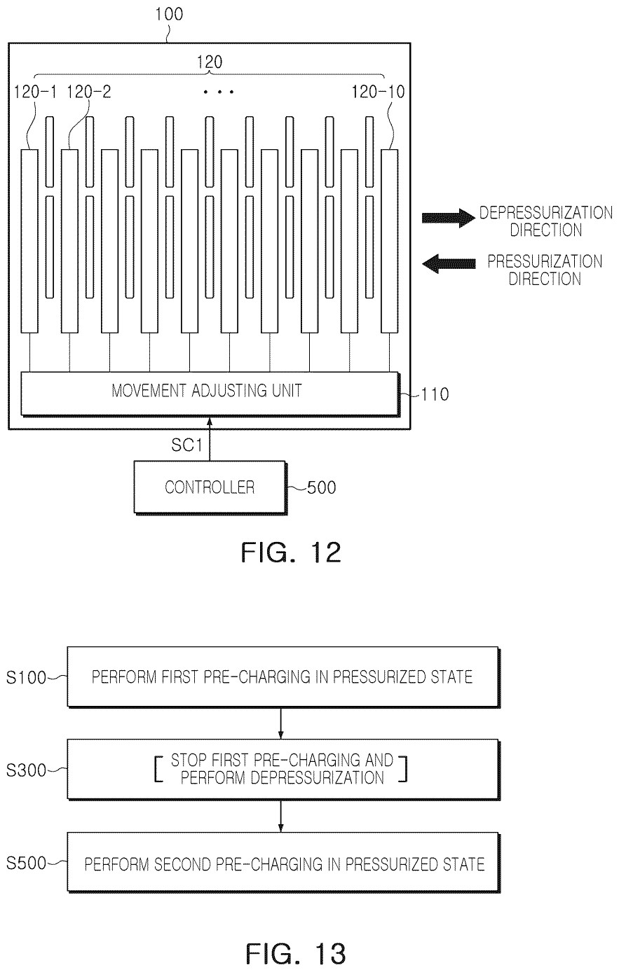

FIG. 12 is an exemplary diagram of a pressurization device.

Referring to FIG. 12, a pressurization device 100 may include a movement adjusting unit 110 and a plate portion 120.

The movement adjusting unit 110 may adjust movement of the plate portion 120 for pressurization against and depressurization on a plurality of battery cells 50 according to a pressure control signal (SC1) of a controller 500.

The plate portion 120 may include a plurality of plates 120_1 to 120_10, and the plurality of plates 120_1 to 120_10 may move and adjust movable plates 120-2 to 120-10 relative to a fixed plate 120-1 in conjunction with the operation of the movement adjusting unit 110, to perform pressurization against or depressurization on the plurality of battery cells 50.

Hereinafter, with reference to FIGS. 13 to 18, a method for pressurized pre-charging (PPC) will be described. In the present disclosure, description of a method for pressurized pre-charging (PPC) and description of the apparatus for pressurized pre-charging (PPC) may be applied complementarily or in common, unless they are mutually exclusive. Therefore, overlapping descriptions may be omitted. Hereinafter, main processes of the method for pressurized pre-charging (PPC) will be described.

FIG. 13 is a flow chart illustrating a method for pressurized pre-charging (PPC) according to an embodiment of the present disclosure.

Referring to FIG. 13, a method for pressurized pre-charging (PPC) according to an embodiment of the present disclosure may be executed by the apparatus 10 for pressurized pre-charging (PPC) illustrated in FIG. 1 or the apparatus 10a for pressurized pre-charging (PPC) illustrated in FIG. 2, and the method for pressurized pre-charging (PPC) according to an embodiment of the present disclosure may include a first pre-charging operation (S100), a depressurization operation (S300), and a second pre-charging operation (S500).

In the first pre-charging operation (S100), a pre-charger 300 of an apparatus for pressurized pre-charging (PPC) (10 of FIG. 1 or 10a of FIG. 2) may perform a first pre-charging (Pch1) for a plurality of battery cells 50 pressurized by a pressurization device 100 before a rest period (Prest).

In the depressurization operation (S300), the pressurization device 100 of the apparatus for pressurized pre-charging (PPC) (10 of FIG. 1 or 10a of FIG. 2) may perform depressurization on the plurality of battery cells 50 during the rest period (Prest) after the first pre-charging operation.

In the second pre-charging operation (S500), the pre-charger 300 may perform a second pre-charging on the plurality of battery cells 50 repressurized by the pressurization device 100 after the depressurization operation (S300).

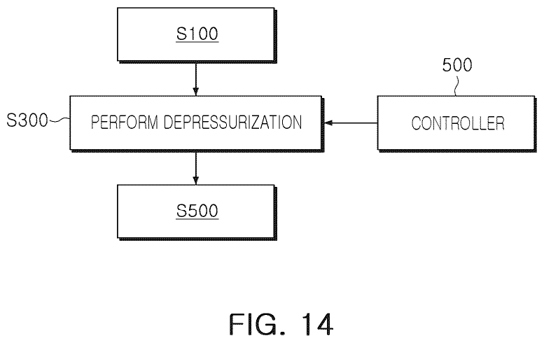

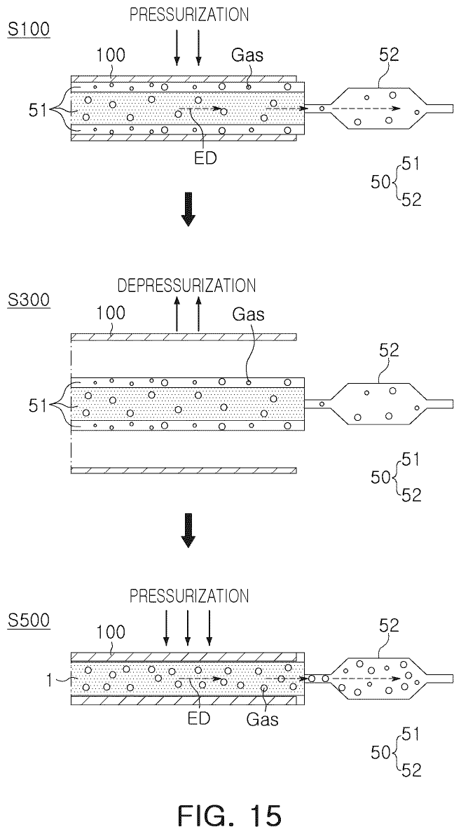

FIG. 14 is an exemplary diagram for a depressurization operation, and FIG. 15 is an explanatory diagram for a pressurization operation, a depressurization operation, and a pressurization operation of pressurized pre-charging (PPC).

Referring to FIGS. 14 and 15, in a depressurization operation (S300), a pressurization device 100 of an apparatus for pressurized pre-charging (PPC) (10 of FIG. 1 or 10a of FIG. 2) may perform depressurization on a plurality of battery cells 50 during a rest period (Prest) according to control of a controller 500.

Referring to FIG. 15, for example, in a first pre-charging operation (S100), plate portions 120 disposed on both sides of a battery cell 50 may move to a pressurization position, to apply a pressure of 600 kgf to the battery cell 50. During this process, gas may be generated. In the present disclosure, a pressure of 600 kgf is only illustrative, and thus, it is not necessary to be limited to the above example.

In the depressurization operation (S300), pressure applied to the plate portions 120 disposed on both sides of the battery cell 50 may be released, to apply pressure applied to the battery cell 50 to be 0 kgf, and in this case, generated gas may be redistributed.

Then, in the second pre-charging operation (S500), the plate portions 120 disposed on both sides of the battery cell 50 may move back to the pressurized position, to apply a pressure of 600 kgf to the battery cell 50 again. In this process, generated gas may move from a cell body 51 to a cell gas pocket (52) in a discharge direction (ED), and may be eventually discharged externally.

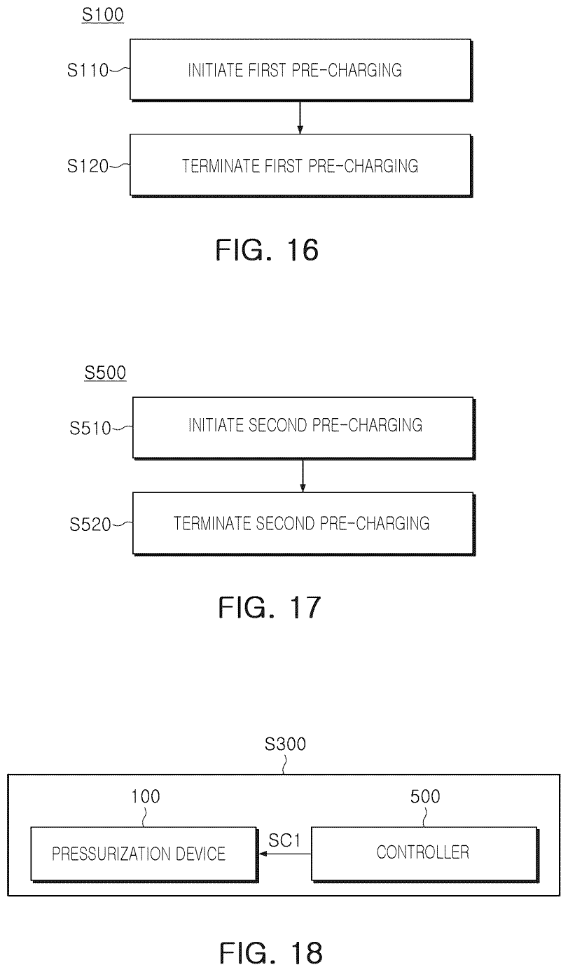

FIG. 16 is an exemplary diagram for a first pre-charging operation.

Referring to FIG. 16, a first pre-charging operation (S100) may include a first initiation operation (S110) and a first termination operation (S120).

In the first initiation operation (S110), a pre-charger 300 of an apparatus for pressurized pre-charging (PPC) (10 of FIG. 1 or 10a of FIG. 2) may initiate a first pre-charging (Pch1) for a plurality of battery cells 50 according to control of a controller 500.

In the first termination operation (S120), the pre-charger 300 of the apparatus for pressurized pre-charging (PPC) (10 of FIG. 1 or 10a of FIG. 2) may terminate the first pre-charging (Pch1) when a charging state (SOC) of the plurality of battery cells 50 exceeds a preset first charging state (SOC1).

FIG. 17 is an exemplary diagram for a second pre-charging operation.

Referring to FIG. 17, a second pre-charging operation (S500) may include a second initiation operation (S510) and a second termination operation (S520).

In the second initiation operation (S510), a pre-charger 300 of an apparatus for pressurized pre-charging (PPC) (10 of FIG. 1 or 10a of FIG. 2) may initiate a first pre-charging (Pch1) for a plurality of battery cells 50 according to control of a controller 500.

In the second termination operation (S520), the pre-charger 300 of the apparatus for pressurized pre-charging (PPC) (10 of FIG. 1 or 10a of FIG. 2) may terminate the second pre-charging (Pch2) when a charging state (SOC) for the plurality of battery cells 50 exceeds a preset second charging state (SOC2).

For example, a rest period (Prest) may correspond to a period (T2−T1) from a point in time (T1) at which a first pre-charging (Pch1) is terminated to a point in time (T2) at which a preset time (Tset) elapses.

FIG. 18 is another exemplary diagram for a depressurization operation.

Referring to FIG. 18, in a depressurization operation (S300), a pressurization device 100 of an apparatus for pressurized pre-charging (PPC) (10 of FIG. 1 or 10a of FIG. 2) may perform depressurization of a plurality of battery cells 50 during the depressurization time (Tpr) set within a rest period (Prest), according to a pressure control signal (SC1) of a controller 500.

For example, a point in time of the depressurization time (Tpr) may be set as a point in time, equal to or later than a point in time of the rest period (Prest), and an end point of the depressurization time (Tpr) may be set as a point in time, equal to or earlier than an end point of the rest period (Prest).

For example, the depressurization time (Tpr) may be set to be 2 minutes or longer and 12 minutes or less.

FIG. 19 is a table diagram for a delta V failure rate according to a depressurization time.

A table for a delta V failure rate illustrated in FIG. 19 may include delta V failure rates according to experimental results for 500 battery cells when depressurization times (Tpr) are 2 minutes, 7 minutes, and 12 minutes, respectively.

In a conventional case (Ref), a delta V failure rate was 0.71% in cases of 2 minutes, 7 minutes, and 12 minutes, while in the present disclosure, a delta V failure rate was 0.54%, 0.00%, and 0.00% in cases of 2 minutes, 7 minutes, and 12 minutes, respectively. It can be seen that the delta V failure rate was improved according to the present disclosure.

FIG. 20 is a graph illustrating delta V according to a depressurization time.

In a graph illustrated in FIG. 20, a vertical axis is delta V, and a horizontal axis is a depressurization time (Tpr).

Referring to the graph illustrated in FIG. 20, it can see that in a conventional case (Ref), delta V (each cell voltage error−median voltage error) has a high failure rate exceeding 0.5 mV, which may be a standard for a good product.

In contrast, according to the present disclosure, when delta V exceeds a standard for a good product of 0.5 mV, it can be seen that there are three cases when the depressurization time (Tpr) is 2 minutes, which has been significant improved, as compared to the conventional case, and when the depressurization time (Tpr) is 7 minutes and 12 minutes, there are no delta V defect at all.

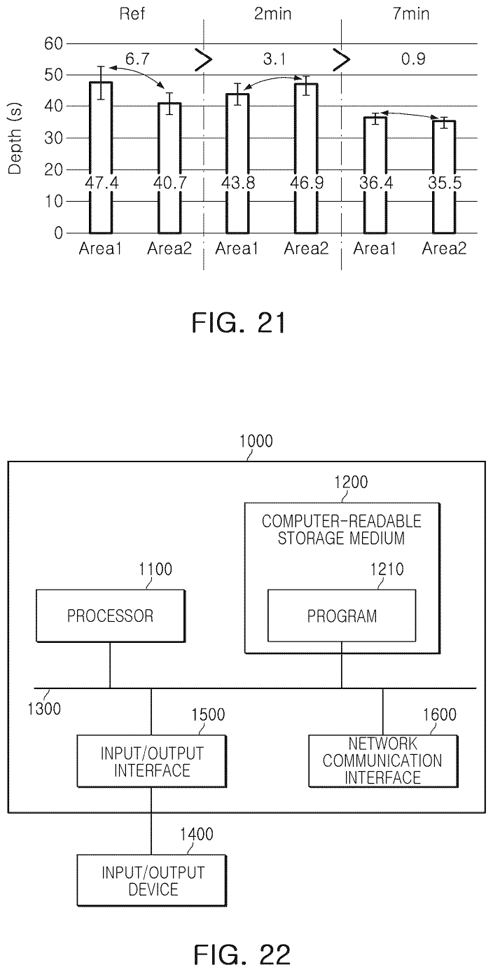

FIG. 21 is a graph for a thickness (Depth(s)) of an SEI layer formed on an electrode surface.

A graph of FIG. 12 may be a graph illustrating results of measuring by using etching time(s) by SEI as a point at which carbon and lithium intersect in a depth direction for a SEI layer formed on an electrode surface, as measured multiple times (e.g., 3 times), by an X-ray photoelectron spectroscopy (XPS) analysis method analyzing components while etching using an argon ion (Ar+) beam.

In a graph illustrated in FIG. 21, a vertical axis is a thickness (Depth (s)), which is a concept of time (seconds) required to etch the SEI layer formed on the electrode surface, and a horizontal axis is two different areas (area 1 (Area1) and area 2 (Area2)).

Referring to the graph illustrated in FIG. 21, according to conventional technology, thickness deviation of the SEI layer formed on the electrode surface in two different areas (area 1 and area 2) may be 6.7 (s), while according to the present disclosure, the depressurization time (Tpr) may be 2 minutes. In this case, thickness deviation of the SEI layer formed on the electrode surface is 3.1 (s), and when the depressurization time (Tpr) may be 7 minutes, and thickness deviation of the SEI layer formed on the electrode surface may be 0.9 (s). According to the present disclosure, compared to the conventional case, it can be seen that local imbalance of the electrode surface may be resolved in that a SEI thickness at each sampling location in a sheet of a negative electrode may be reduced. This may contribute to stable voltage formation of the electrode.

FIG. 22 is a block diagram of a computing device that may fully or partially implement an apparatus and method for pressurized pre-charging according to an embodiment of the present disclosure.

As illustrated in FIG. 22, a computing device 1000 may include at least one processor 1100, a computer-readable storage medium 1200, and a communication bus 1300.

The processor 1100 may allow the computing device 1000 to operate according to the example embodiments mentioned above. For example, the processor 1100 may execute one or more programs stored in the computer-readable storage medium 1200. The one or more programs may include one or more computer-executable instructions, which, when executed by the processor 1100, may be configured to allow the computing device 1000 to perform operations according to the example embodiments.

The computer-readable storage medium 1200 may be configured to store computer-executable instructions, program code, program data, and/or other suitable forms of information. A program 1210 stored on a computer-readable storage medium 1200 comprises a set of instructions executable by the processor 1100. In an embodiment, the computer-readable storage medium 1200 may be a memory (volatile memory such as random access memory, non-volatile memory, or a suitable combination thereof), one or more magnetic disk storage devices, optical disk storage devices, flash memory devices, any other form of storage medium that may be accessed by the computing device 1000 and capable of storing desired information, or a suitable combination thereof.

The communication bus 1300 may interconnect various other components of the computing device 1000, including the processor 1100 and the computer-readable storage medium 1200.

The computing device 1000 may also include at least one input/output interface 1500 providing an interface for at least one input/output device 1400, and at least one network communication interface 1600. The input/output interface 1500 and the network communication interface 1600 may be connected to the communication bus 1300. The network may be any one of a cellular network, such as a global system for mobile communications (GSM), an enhanced data rate for GSM evolution (EDGE), a general packet radio service (GPRS), a code division multiple access (CDMA), a time division-CDMA (TD-CDMA), a universal mobile telecommunications system (UMTS), a long term evolution (LTE), or other cellular network.

The input/output device 1400 may be connected to other components of the computing device 1000 via the input/output interface 1500. Examples of the input/output devices 1400 may include input devices such as a pointing device (such as a mouse or trackpad), a keyboard, a touch input device (such as a touchpad or a touchscreen), a voice or sound input device, various types of sensor devices and/or photographing devices, and/or output devices such as a display device, a printer, a speaker, and/or a network card. Examples of the input/output devices 1400 may be included in the computing device 1000 as a component constituting the computing device 1000, or may be connected to the computing device 1000 as a separate device distinct from the computing device 1000.

Embodiments of the present disclosure may include a program for performing methods described herein on a computer, and a computer-readable recording medium including the program. The computer-readable recording medium may include a program command, a local data file, a local data structure, or the like, alone or in combination. The medium may be specially designed and configured for the present disclosure, or may be commonly used in a field of computer software. Examples of computer-readable recording media may include magnetic media such as a hard disk, a floppy disk, or a magnetic tape, optical recording media such as a CD-ROM or a DVD, and hardware devices specifically configured to store and execute program instructions such as a ROM, a RAM, a flash memory, or the like. Examples of the programs may include not only machine language codes such as those generated by a compiler, but also high-level language codes that may be executed by a computer using an interpreter or the like.

According to an aspect of the present disclosure, gas trapped on an electrode surface may be redistributed by performing depressurization during a rest period between a first pre-charging and a second pre-charging in a battery formation process, thereby contributing to stabilization of a solid electrolyte interphase (SEI) formed on the electrode surface of a battery cell.

In addition, an effect of improving delta V defects in a formation charge process may be provided.

Various advantages and effects of the present disclosure are not limited to the above-mentioned contents, and other technical effects that have not been mentioned can be more easily understood in the process of explaining the specific implementation of the present disclosure from the description below.

Only specific examples of implementations of certain embodiments may be described. Variations, improvements and enhancements of the disclosed embodiments and other embodiments may be made based on the disclosure of this patent document.

What is claimed is:

1. An apparatus for pressurized pre-charging comprising:
a pressurization device applying pressure to or releasing applied pressure from a plurality of battery cells; and
a pre-charger performing first pre-charging on the plurality of battery cells in a state pressurized by the pressurization device before a rest period, stopping the first pre-charging during the rest period, and performing second pre-charging on the plurality of battery cells in a state pressurized by the pressurization device after the rest period,
wherein the pressurization device performs pressurization against the plurality of battery cells for the first pre-charging and the second pre-charging, and performs depressurization on the plurality of battery cells during the rest period.

2. The apparatus of claim 1, further including a controller controlling the pressurization device to perform depressurization on the plurality of battery cells during the rest period between the first pre-charging and the second pre-charging.

3. The apparatus of claim 2, wherein the pressurization device performs depressurization on the plurality of battery cells during the rest period under control of the controller.

4. The apparatus of claim 2, wherein the pre-charger includes a first pre-charging unit including a first charging unit and a first charging state determination unit, and
wherein the first charging unit initiates the first pre-charging for the plurality of battery cells according to a first control signal of the controller, and terminates the first pre-charging according to a first charging completion signal input from the first charging state determination unit, and
the first charging state determination unit compares a charging state for the plurality of battery cells with a preset first charging state, and outputs the first charging completion signal to the first charging unit when the charging state exceeds the first charging state.

5. The apparatus of claim 2, wherein the pre-charger includes a second pre-charging unit including a second charging unit and a second charging state determination unit, and
wherein the second charging unit initiates the second pre-charging for the plurality of battery cells according to a second control signal of the controller, and terminates the second pre-charging according to a second charging completion signal input from the second charging state determination unit, and
the second charging state determination unit compares a charging state for the plurality of battery cells with a preset second charging state, and outputs the second charging completion signal to the second charging unit when the charging state exceeds the second charging state.

6. The apparatus of claim 1, wherein the rest period corresponds to a period from a point in time at which the first pre-charging is terminated to a point in time at which a preset time elapses.

7. The apparatus of claim 2, wherein the controller generates a pressure control signal for controlling depressurization of the plurality of battery cells during a depressurization time set within the rest period, and provides the pressure control signal to the pressurization device.

8. The apparatus of claim 7, wherein a point in time of the depressurization time is set as a point in time, equal to or later than a point in time of the rest period, and
an end point of the depressurization time is set as a point in time, equal to or earlier than an end point of the rest period.

9. The apparatus of claim 7, wherein the depressurization time is set to be 2 minutes or longer and 12 minutes or less.

10. The apparatus of claim 2, wherein the pressurization device includes a movement adjusting unit and a plate portion, and
wherein the movement adjusting unit adjusts movement of the plate portion for pressurization against and depressurization on the plurality of battery cells according to a pressure control signal of the controller, and
the plate portion includes a plurality of plates, and the plurality of plates move and adjust a movable plate relative to a fixed plate in conjunction with an operation of the movement adjusting unit, to perform pressurization against or depressurization on the plurality of battery cells.

11. A method for pressurized pre-charging comprising:
a first pre-charging operation of performing first pre-charging on a plurality of battery cells pressurized by a pressurization device before a rest period, with a pre-charger;
a depressurization operation of performing depressurization on the plurality of battery cells during the rest period after the first pre-charging operation, by the pressurization device; and
a second pre-charging operation of performing second pre-charging on the plurality of battery cells repressurized by the pressurization device after the depressurization operation, by the pre-charger.

12. The method of claim 11, wherein, in the depressurization operation, the pressurization device performs depressurization on the plurality of battery cells during the rest period according to control of a controller.

13. The method of claim 12, wherein the first pre-charging operation includes:
a first initiation operation of initiating the first pre-charging for the plurality of battery cells by the pre-charger according to control of the controller; and
a first termination operation of terminating the first pre-charging when a charging state of the plurality of battery cells exceeds a preset first charging state.

14. The method of claim 12, wherein the second pre-charging operation includes:
a second initiation operation of initiating the second pre-charging for the plurality of battery cells by the pre-charger according to control of the controller; and
a second termination operation of terminating the second pre-charging when a charging state of the plurality of battery cells exceeds a preset second charging state.

15. The method of claim 11, wherein the rest period corresponds to a period from a point in time at which the first pre-charging is terminated to a point in time at which a preset time elapses.

16. The method of claim 12, wherein the depressurization operation performs depressurization on the plurality of battery cells during a depressurization time set within the rest period range according to a pressure control signal of the controller, by the pressurization device.

17. The method of claim 16, wherein a point in time of the depressurization time is set as a point in time, equal to or later than a point in time of the rest period, and
an end point of the depressurization time is set as a point in time, equal to or earlier than an end point of the rest period.

18. The method of claim 16, wherein the depressurization time is set to be 2 minutes or longer and 12 minutes or less.
